(19) United States
(12) Patent Application Publication
(10) Pub. No.: US 2001/0027463 A1
(43) Pub. Date: Oct. 4, 2001

(54) Task priority decision apparatus and method, workflow system, work processing method, and recording medium

(75) Inventor: Yoko Kobayashi, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 09/794,429

(22) Filed: Feb. 27, 2001

(30) Foreign Application Priority Data
Mar. 22, 2000 (JP) 2000-084741
Mar. 22, 2000 (JP) 2000-084674

(51) Int. Cl. G06F 9/00

(52) U.S. Cl. 709/103

(57) ABSTRACT

There is provided a task priority decision apparatus used in a work processing system that performs a work process by sending and receiving task information. The apparatus is capable of automatically determining process priority of a piece of information concerning a task. A task information extracting unit extracts a piece of task information. A related document information acquiring unit acquires document information related to the piece of task information. A process deadline determining information retrieving unit extracts process deadline determining information from the document information. A process deadline determining unit determines a process deadline for the piece of task information on the basis of the process deadline determining information.

### BACKGROUND OF THE INVENTION

1. Field of the Invention

The present invention relates to a task priority decision apparatus and method which decide process priority of items of information concerning task, and to a recording medium storing a program that causes a computer to implement such an apparatus and method. Further, the present invention is concerned with a workflow system and a work processing method for performing a given work process by computerizing a task-related document and circulating the computerized documents. The present invention also relates to a computer-readable recording medium storing a program that causes a computer to implement the workflow system and the work processing method. More particularly, the present invention relates to a task priority decision apparatus and method for deciding process priority of items of information concerning task transmitted over an electronic communication medium and to a program that causes a computer to implement the task priority decision apparatus and method. Furthermore, the present invention is concerned with a workflow system and a work processing method each having the function of managing task documents. Moreover, the present invention relates to a computer-readable recording medium storing a program that causes a computer to implement the workflow system and the work processing method.

2. Description of the Related Art

Recently, paperless workflow systems for implementing a plurality of tasks have recently been introduced. A task document, such as an application form or a request form for managerial decision, is computerized and stored in a database. Task information, which may include a task item and a link to related document information, is circulated through an electronic communication line. Such a workflow system is advantageous in terms of efficiency of work, management of workflow, convenience of maintaining a task record and reduction of paper resources. Thus, it is expected that such a workflow system will make further progress and come into wide use in various fields.

The workflow system is utilized as follows. First, a task originating person uses his or her own computer terminal to produce task information on a task and related document information in a predetermined format. Further, the task originating person defines plan definition information, which indicates a route along which the task information and document information related thereto should be circulated. The document information is associated with the task information and is stored in a given database. The task information is sent, through the electronic communication line, to a superior who has the right to access the task information in accordance with a definition described in the plan definition information.

A task information list, which is a list of pieces of task information sent as described above, is displayed on a screen of a computer terminal of the superior who receives the pieces of task information. The superior selects a desired piece of task information, namely one task, from the task information list displayed on the screen. Then, the document information associated with the selected task information is read out from the database, and is read by the superior. The superior who has read the document information confirms the contents of the document, and adds comments to the document. Then, the superior approves the document information with his/her comments added. Thereafter, the task information including the added comments is sent by the superior to his or her superior in accordance with the definition described in the plan definition information. Additional comments are added to the task information, which is further circulated along the circulating route. The task information that has been completely circulated along the circulating route is subjected to a final process, such as a settlement process in a settlement process department, which completes the workflow.

Document information concerning a task created by the task-originating person remains in the document database even after the task is completed. Thus, a later task originator who wishes to perform a similar task can utilize the document information previously produced and stored in the document database, so that creation of a new task document is facilitated.

However, the work process using the conventional workflow system has a disadvantage in that the process priority among the transmitted pieces of task information is not clearly indicated, so that it is different to complete the tasks in accordance with their exact priorities.

The task information concerning each task is displayed in the form of a task information list that provides comparatively simple items of the task information only, such as the title of the task information and the task-originating person. Thus, it is generally difficult to understand the details of the contents of the tasks by merely reading the task information lists. Thus, the degree of urgency of each task cannot readily be determined from these lists. In practice, a person who must read the task documents one by one and confirm the contents thereof in order to assign priority to the tasks. Alternatively, each person involved in a task may determine process priority of the task and indicate the priority in the associated task information.

The conventional workflow system has a further disadvantage described below. A person who originates a new task can obtain, from the document database, information concerning only documents that were created by the task originators in the past. In other words, the above person cannot obtain, from the document information, the plan definition information related to each past document. Even if a similar task has been previously originated, the person who originates a new task must retrieve corresponding plan definition information by a particular manner. This prevents efficient setting of plan definition information.

### SUMMARY OF THE INVENTION

Taking the above into consideration, an object of the present invention is to provide a task priority decision apparatus capable of automatically making a decision on process priority of information concerning a task and clearly indicating priority.

Another object of the present invention is to provide a task priority decision method capable of automatically making a decision on process priority of information concerning a task and clearly indicating priority.

Yet another object of the present invention is to provide a workflow system capable of obtaining plan definition information related to information concerning a document by referring to document information previously created so that a new piece of plan definition information concerning information on a new document can be set efficiently.

A further object of the present invention is to provide a work processing method capable of obtaining plan definition information related to information concerning a document by referring to document information previously created so that a new piece of plan definition information concerning information on a new document can be set efficiently.

To accomplish the above objects, according to the present invention, there is provided a task priority decision apparatus. This apparatus includes: a task information extracting unit for extracting a piece of task information; a related document information acquiring unit for acquiring document information related to the piece of task information extracted by the task information extracting unit; a process deadline determining information retrieving unit for extracting process deadline determining information from the document information acquired by the related document information acquiring unit; and a process deadline determining unit for determining a process deadline for the piece of task information on the basis of the process deadline determining information extracted by the process deadline determining unit.

To accomplish the above objects, according to the present invention, there is provided a task priority decision method. This method includes the steps of: extracting a piece of task information; acquiring document information related to the piece of task information extracted; extracting process deadline determining information from the document information acquired; determining a process deadline for the piece of task information on the basis of the process deadline determining information; and calculating a remaining term up to the process deadline.

To accomplish the above objects, according to the present invention, there is provided a workflow system performing a given work process by circulating a document stored in a document management system for managing task documents, the workflow system including: plan definition information associating means for associating document information concerning the task documents with plan definition information that defines a way to circulate the task documents: and plan definition information extracting means for extracting the plan definition information associated with the task documents stored in the document management system.

To accomplish the above objects, according to the present invention, there is provided a work processing method for performing a given work by computerizing and circulating a task document, including the steps of: associating plan definition information defining a way to circulate the task document with task information formed by computerizing the task document; storing the document information with which the plan definition information is associated; and extracting the plan definition information associated with the document information extracted.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a block diagram of a structure of a task priority decision apparatus according to a first embodiment of the present invention;

FIG. 2(A) illustrates an example of a keyword condition table;

FIG. 2(B) illustrates an example of a plan condition table;

FIG. 3(A) illustrates an example of a display format master;

FIG. 3(B) illustrates an example of an icon master;

FIG. 4 illustrates an example of a condition table registration form that is displayed at the time of registering the keyword condition table and the plan condition table;

FIG. 5 illustrates an example of a task information list;

FIG. 6 is a flowchart of an operation of the task priority decision apparatus according to the first embodiment of the present invention;

FIG. 7 is a block diagram of a structure of a workflow system according to a second embodiment of the present invention;

FIG. 8 illustrates an example of plan definition information;

FIG. 9 is a flowchart of an operation of setting document information and plan definition information performed by a first task-originating person who uses a work processing apparatus;

FIG. 10 is a flowchart of an operation of extracting plan definition information created previously performed by a second task-originating person who uses a work processing apparatus;

FIG. 11(A) is a flowchart of a first example of an associating process and illustrates the contents of step S103 shown in FIG. 9 in the first example of the associating process;

FIG. 11(B) is another flowchart of the first example of the associating process and illustrates the contents of step S114 shown in FIG. 10 in the first example of the associating process;

FIG. 12(A) is a flowchart of a second example of an associating process and illustrates the contents of step S103 shown in FIG. 9 in the second example of the associating process;

FIG. 12(B) is another flowchart of the second example of the associating process and illustrates the contents of step S114 shown in FIG. 10 in the second example of the associating process;

FIG. 13 illustrates a case where a plan ID for specifying a piece of plan definition information is set in an area for describing a comment on an attached document;

FIG. 14(A) is a flowchart of a third example of an associating process and illustrates the contents of step S103 shown in FIG. 9 in the third example of the associating process;

FIG. 14(B) is another flowchart of the third example of the associating process and illustrates the contents of step S114 shown in FIG. 10 in the third example of the associating process;

FIG. 15(A) is a flowchart of a fourth example of an associating process and illustrates the contents of step S103 shown in FIG. 9 in the fourth example of the associating process;

FIG. 15(B) is another flowchart of the fourth example of the associating process and illustrates the contents of step S114 shown in FIG. 10 in the fourth example of the associating process;

FIG. 16(A) is a flowchart of a fifth example of an associating process and illustrates the contents of step S103 shown in FIG. 9 in the fifth example of the associating process;

FIG. 16(B) is another flowchart of the fifth example of the associating process and illustrates the contents of step S114 shown in FIG. 10 in the fifth example of the associating process;

FIG. 17(A) is a flowchart of a sixth example of an associating process and illustrates the contents of step S103 shown in FIG. 9 in the sixth example of the associating process;

FIG. 17(B) is another flowchart of the sixth example of the associating process and illustrates the contents of step S114 shown in FIG. 10 in the sixth example of the associating process; and

FIG. 18 illustrates a case where a plan ID for specifying a piece of plan definition information in a folder in which a task document to be circulated is stored.

### DESCRIPTION OF THE PREFERRED EMBODIMENTS

A description will be given of preferred embodiments of the present invention with reference to the accompanying drawings.

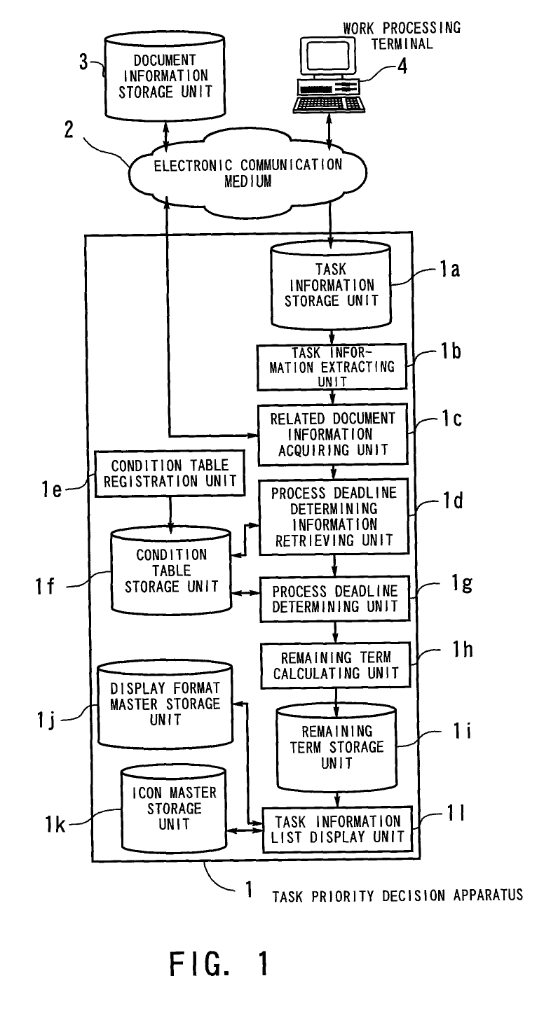

First, a description will be given of a first embodiment of the present invention with reference to FIG. 1.

FIG. 1 illustrates a structure of a task priority decision apparatus 1 according to the first embodiment of the present invention. The task priority decision apparatus 1 includes a task information storage unit 1a, a task information extracting unit 1b, a related document information acquiring unit 1c, a process deadline determining information retrieving unit 1d, a condition table registering unit 1e, and a condition table storage unit 1f. Further, the task priority decision apparatus 1 includes a process deadline determining unit 1g, a remaining term calculating unit 1h, a remaining term storage unit 1i, a display master format storage unit 1j, an icon master storage unit 1k, and a task information list display unit 1l.

The task information storage unit 1a stores task information transmitted. The task information extracting unit 1b extracts a piece of task information concerning a task from the task information storage unit 1a. The related document information acquiring unit 1c acquires a piece of document information related to the task information extracted by the task information extracting unit 1b. The process deadline determining information retrieving unit 1d extracts process deadline determining information from the document information acquired by the related document information acquiring unit 1c. The condition table registering unit 1e makes a registration of a keyword condition table and a plan condition table. The condition table storage unit 1f stores the keyword condition table and the plan condition table. The process deadline determining unit 1g determines the process deadline for the task involved in the extracted task information in accordance with the process deadline determining information extracted by the process deadline determining information unit 1d. The remaining term calculating unit 1h calculates the remaining term up to the process deadline determined by the process deadline decision unit 1g. The remaining term storage unit 1i stores information indicative of the remaining term calculated by the remaining term calculating unit 1h. The display format master storage unit 1j defines a display format of the task information list so that the format depends on the remaining term. The icon master storage unit 1k defines an icon corresponding to plan information. The task information list display unit 1l displays the task information list. The task information storage unit 1a and the associated document acquiring unit 1c are connected to an electronic communication medium 2 to which a document information storage unit 3 and a work processing terminal 4 are connected. The work process terminal 4 is used to input task information. FIG. 1 illustrates only one work process terminal 4 for the sake of simplification. However, a plurality of work process terminals 4 may be connected to the electronic communication medium 2.

Here, several terms used in the specification are defined as follows. Task information is index information related to a task, and includes an item of the task, the name of a task originating person, and information concerning a link to related document information. Document information is text information describing the contents of the task information in detail. The document information is associated with related task information and is stored in the document information storage unit 3. Process deadline determining information is used to determine a process deadline for a task indicated by task information, and corresponds to a given keyword, plan information and so on. These pieces of information are contained in document information. The keyword is a given word included in document information. The present embodiment of the invention employs, as a keyword, a word that explicitly or implicitly indicates a process deadline for the involved task. The word that explicitly indicates the process deadline is a word or phrase that describes a specific deadline such as “by” or “before the end of this week”. The word that implicitly specifies the process deadline is a word or phrase that abstractly represents a deadline such as “urgent” or “rush”. The plan information indicates what task the related document information is directed to. The plan information is added to the related document information and is then transmitted. The kind of document information indicated by the plan information is, for example, “a request form for managerial decision” or “application for a holiday”. The keyword condition table is made up of a keyword and a process deadline associated with that keyword. The plan condition table is made up of plan information and a process deadline associated with such plan information.

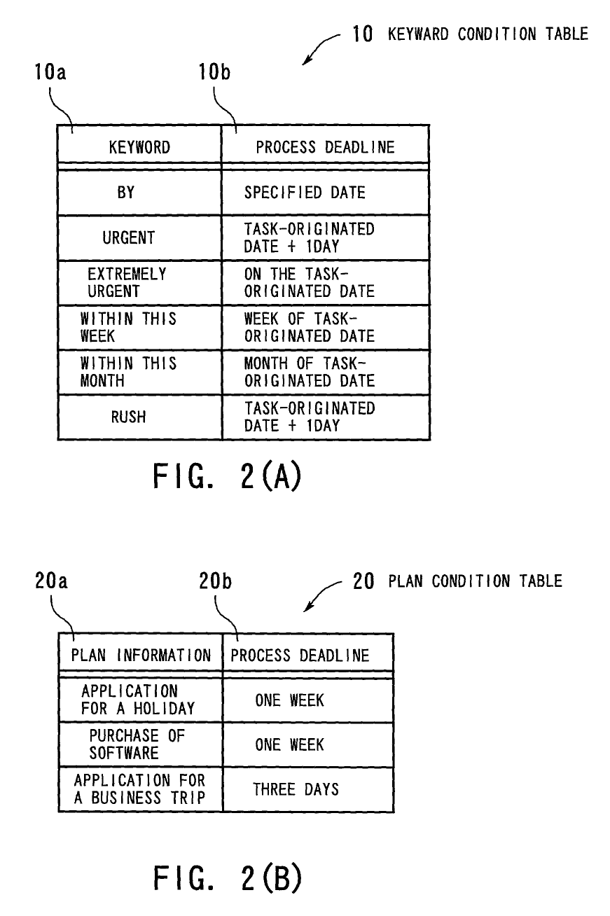

FIG. 2(A) shows an example of a keyword condition table 10 stored in the condition table storage unit 1f, and FIG. 2(B) shows an example of a plan condition table stored therein.

The keyword condition table 10 is made up of a keyword 10a, such as “by” or “urgent”, and a process deadline 10b associated therewith one by one. When one of the keywords 10a is specified, the corresponding process deadline 10b can be automatically obtained. A task is required to be completed by the corresponding process deadline 10b. A more specific process deadline for a task can be defined by the combination of the process deadline 10b and a date before or after the keyword 10a, or the combination of the process deadline 10b and the task-originated date.

The task condition table 20 is made up of plan information 20a, such as “application for a holiday” or “purchase of software”, and a process deadline 20b associated therewith one by one. When one of the pieces of plan information 20a is specified, the corresponding process deadline 20b can be automatically obtained. A task is required to be completed by the corresponding process deadline. A specific term, such as “one week”, or “three days” is set as the process deadline 20b. A more specific process deadline for a task can be defined by adding the specific term to the task-originated date.

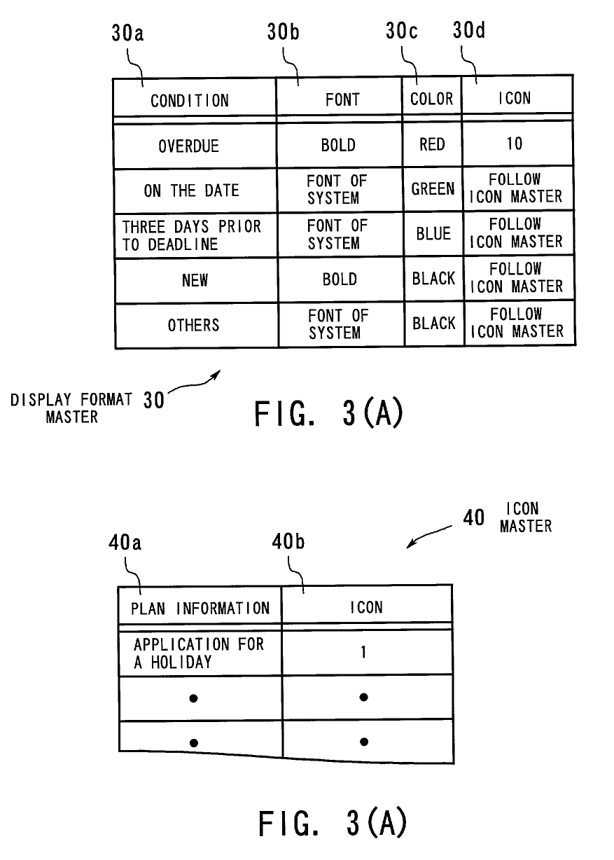

FIG. 3(A) illustrates an example of a display format master 30 stored in the display format master storage unit 1j, and FIG. 3(B) illustrates an example of an icon master 40 stored in the icon master storage unit 1k.

The display format master 30 is made up of a condition 30a indicating the remaining term up to the process deadline such as “overdue” or “on the day”, a font 30b indicating the font of displayed letters such as “bold”, the color of displayed letters such as “red” or “green”, and an icon 30d indicating the kind of icon to be displayed. The font 30b, the color 30c and the icon 30d are associated with the condition 30a on a per-condition basis. When one of the conditions 30a is specified, the corresponding font 30b, color 30c and icon 30d can be fixed.

The icon master 40 defines a respective icon corresponding to plan information for each task, and is made up of plan information 40a such as “application for a holiday”, and an icon 40b indicating a number corresponding to the kind of icon corresponding to the plan information 40b.

Next, a description will be given of an operation of the task priority decision apparatus 1.

A user who utilizes the task priority decision apparatus 1 performs, in advance of practical use thereof, a registration operation on the keyword condition table 10 and the plan condition table 20 by using the condition table registering unit 1e. First, a description will be given of a registration operation on the keyword condition table 10 and the plan condition table 20.

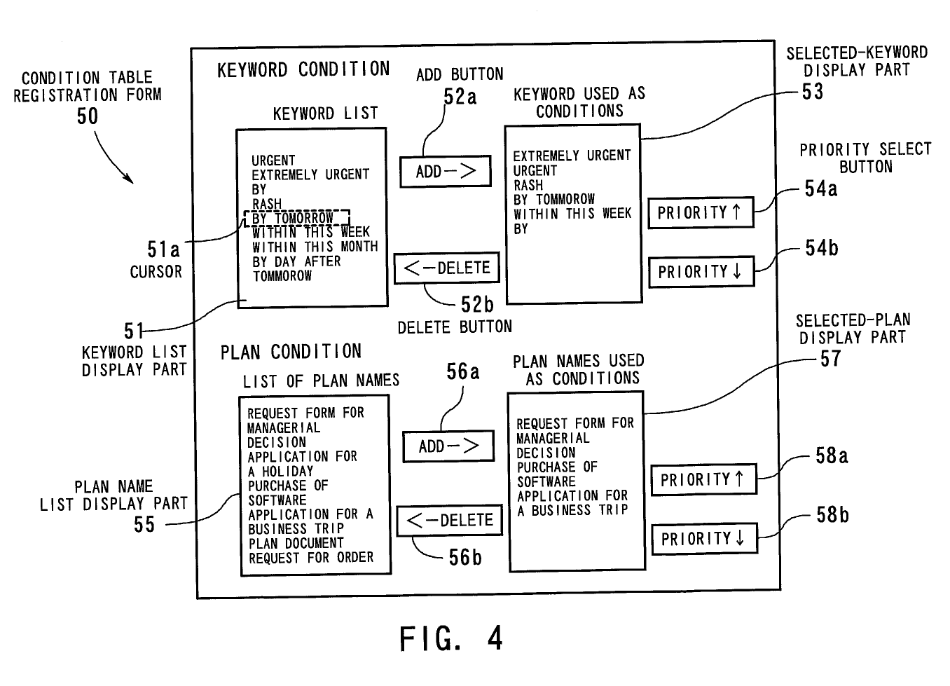

FIG. 4 illustrates a condition table registration form 50, which is displayed when the user performs the registration operation on the keyword condition table 10 and the plan condition table 20.

The condition table registration form 50 includes a keyword list display part 51, a cursor 51a, an add button 52a, a delete button 52b, a selected-keyword display part 53, priority select buttons 54a and 54b, a plan name list display part 55, an add button 56a, a delete button 56b, a selected-plan display part 57, and priority select buttons 58a and 58b.

The keyword list display part 51 displays a list of candidates of keywords to be registered. The cursor 51a specifies a keyword or the like. The add button 52a is used to add a keyword. The delete button 52b is used to delete a keyword. The selected-keyword display part 53 displays a selected keyword. The priority select buttons 54a and 54b are used to select priority of the selected keyword and set a process deadline involved therein. The plan name list display part 55 displays a list of candidates of items of plan information. The add button 56a is used to add an item of plan information. The delete button 56b is used to delete an item of plan information. The selected-plan display part 57 displays selected pieces of plan information. The priority select buttons 58a and 58b are used to set priority of each of the items of selected plan information and a process deadline for each of the items of selected plan information.

When the user performs the registration operation on the keyword condition table 10, the user selects a keyword displayed in the keyword list display part 51, and clicks the selected keyword. This causes the cursor 51a to move on the selected keyword. In the keyword selection, only one keyword may be selected or a plurality of keywords may be selected at one time. Next, the user clicks the add button 52a. After the user selects at least one keyword, the user clicks the add button 52a. Thus, the selected keyword, on which the cursor 51a is placed, is displayed in the selected-keyword display part 53. If the user wishes to delete a keyword displayed in the selected-keyword display part 53 from selection, the user moves the cursor 51a on the keyword to be deleted, and clicks the delete button 52b. This causes the selected keyword to be deleted from display on the selected-keyword display part 53 and to be excluded from selection. When all the keywords that the user wishes to use are selected, the user operates the priority select buttons 54a and 54b to set priorities of the selected keywords. More particularly, the selected keywords are displayed from the top of the selected-keyword display part 53 in the decreasing order of priority. When the user moves the cursor 51a on a selected keyword and clicks the priority select button 54a, the priority of the selected keyword on which the cursor 51a is placed is interchanged with that of the selected keyword located just above the former keyword. Alternatively, when the user clicks the priority select button 54b, the priority of the keyword with the cursor 51a placed thereon is interchanged with that of the keyword located just below the former keyword. By this manner, the priority of each of the keywords is determined. A deadline is automatically given to each of the keywords in accordance with their priorities. Then, the registering operation on the keyword condition table 10 is completed. The selected keywords are arranged in the column of keyword 10a of the keyword condition table 10, and the deadlines automatically given thereto are arranged in the column of deadline 10b. The user may voluntary set the deadlines for the selected keywords.

The registration of the plan condition table 20 is performed in the same manner as that of the keyword condition table 10. Then, the keyword condition table 10 and the plan condition table 20 are stored in the condition table storage unit 1f, and then the registration operation thereon is completed.

A description will be given of a priority decision process of the task priority decision apparatus 1.

A task originating person uses the work process terminal 4 and obtains, from a database for a workflow management that is not shown for the sake of simplicity, a template for producing task information and document information. Then, the person produces task information and associated document information in accordance with the template. After the task originating person completes producing of the task information and the associated work information, the person transmits the information via the electronic communication medium 2. The task information and document information thus transmitted are received by the task priority decision apparatus 1. Then, the task information is stored in the task information storage unit la, and the document information is stored in the document information storage unit 3. A plurality of task originating persons may send their own task information and associated document information a plurality of times. The task information and document information sent by the task originating persons are serially stored in the task information storage unit 1a and the document information storage unit 3, respectively.

The task priority decision apparatus 1 makes a decision on process priorities of tasks indicated by pieces of task information as follows. First, the task information extracting unit 1b extracts a piece of task information from the task information storage unit 1a. The piece of task information extracted from the task information storage unit 1a is sent to the related document information acquiring unit 1c.

The associated document acquiring unit 1c receives the task information and accesses the document information storage unit 3 through the electronic communication medium 2. Then, the related document acquiring unit 1c extracts document information that is linked to the received task information. The document information extracted from the document information storage unit 3 is sent to the related document information acquiring unit 1c through the electronic communication medium 2. Then, the acquiring unit 1c sends the received document information to the process deadline determining information retrieving unit 1d.

The retrieving unit 1d looks up the keyword condition table 10 and the plan condition table 20 stored in the condition table storage unit 1f. Then, the retrieving unit 1d searches the whole document information in order to determine whether the document information includes any of the keywords defined in the keyword condition table 1 or any of the pieces of the plan information 20a defined in the plan condition table 20. If the document information contains any of the keywords 10a or any of the pieces of the plan information 20a, the process deadline determining information retrieving unit 1d extracts the matched keyword 10a and/or plan information 20b, and sends it to the process deadline determining unit 1g.

Then, the unit 1g extracts the process deadlines 10b and/or 20b respectively corresponding to the received keyword 10a and plan information 20a from the keyword condition table 10 and/or the plan condition table 20. Then, the process deadline determining unit 1g determines specific deadlines for the task based on the extracted process deadlines 10b and 20b.

The specific deadline corresponding to the received keyword 10a is determined on the basis of the combination of the process deadline 10b and the task-originated date placed before or after the keyword 10a, or the combination with the task-originated date, as has been described previously. For instance, if a task document includes a phrase “by February 10”, the work “by” matches registered keyword “by” in the keyword condition table 10, and the deadline 10b associated with “by” is “specified date”. The date indicated before or after the word “by” in the phrase “by February 10” is “February 10”. Therefore, the “specified date” is “February 10”, which is determined as the specific process deadline. As another example, if a task document was created on February 2 and includes a work “urgent”, this word matches registered keyword “urgent” in the keyword condition table 10, and the process deadline 10b for registered keyword “urgent” is “task-originated date+one day”. Since the task-originated date in the above example is February 2, “February 3” obtained by adding one day to the task-originated date is determined as the specific process deadline.

The specific process deadline is determined on the basis of the process deadline 20b corresponding to the plan information 20a in such a way as to add the process deadline 20b to the task-originated date. For example, if a task document of an application for a holiday was created on February 2, “application for a holiday” that is one of the pieces of plan information 20a matches the task document, and the process deadline 20b corresponding to plan information “application for a holiday” is “one week”. Since the task-originated date is February 2, the specific process deadline is determined as February 9 obtained by adding one week to February 2.

The specific process deadline determined as described above is sent to the remaining term calculating unit 1h, which calculates the remaining term up to the process deadline. The remaining term is calculated based on the date when the task is processed. The calculating unit 1h calculates the remaining term for not only a task before its deadline but also an overdue task. The remaining term of an overdue task may be expressed using a minus sign such as (remaining term—five days). Alternatively, an overdue task may be processed by a fixed manner directed thereto. The remaining term thus calculated is stored in the remaining term storage unit 1i in such a way as to be associated with the corresponding task information.

Then, the task information extracting unit 1b extracts another piece of task information from the task information storage unit 1a, and the above-mentioned process is repeatedly performed. All of the pieces of task information stored in the task information storage unit 1 are processed as described above, and the remaining terms for the pieces of task information are stored in the remaining term storage unit 1i. Thereafter, the task information list display unit 1l displays a task information list of the pieces of task information that have been processed as described above.

A display fashion of the task information list is based on the remaining term of each task stored in the remaining term storage unit 1i, and is performed in accordance with the definition of the display format master 30 stored in the display format master storage unit 1j. For example, for an overdue task, the condition 30a in the display format master 30 is “overdue”, and the corresponding font 30b, color 30c and icon 30d are respectively “bold”, “red and “10”. In this case, the task information list has a piece of task information that is displayed with a bold font of red and is given the icon specified by number “10”. For a task that is to be processed today and is related to an application for a holiday, the condition 30a in the display format master 30 is “the appointed date”, and the corresponding font 30b, color 30c and icon 30d are respectively “font of system”, “green” and “follow icon master”. Since the task information being considered relates to application for a holiday, the plan information 40a in the icon master 40 stored in the icon master storage unit 1k is “application for a holiday”, and an icon specified by number “1” is given as icon 40b. In this case, the task information list has task information that is displayed with a green font of the system and is given the icon specified by number “10”. As described above, the display format of the task information list is changed on the basis of the length of the remaining term up to the process deadline. The task information list is displayed so that the tasks are arranged from the top thereof in the increasing order of the remaining term. This facilitates to displaying priority of each task more clearly.

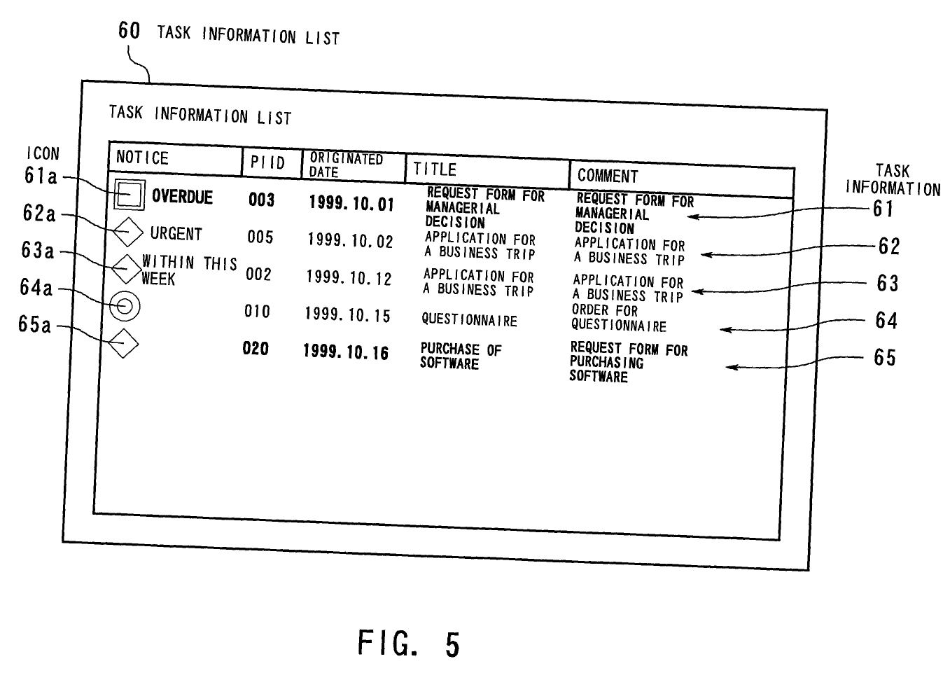

FIG. 5 illustrates an example of a display of the task information list 60 that is created as described above. The task information list 60 includes five pieces 61-65 of task information (five tasks), and includes columns of “Notice”, “PIID”, “originated date”, “title” and “comment”. The column “Notice” indicates the remaining term for each task. The column “PIID” is an ID of the task-originating person involved in a task. The column “title” indicates the title of a task. The column “comment” indicates a comment on a task. Further, the icon given to each task is displayed in the column “Notice”. For example, the task 61 is overdue, and an indication “overdue” and a corresponding icon 61a are displayed in the column “Notice”. In the case where the task information list 60 follows the display format master 30, an item of the task information 61 are displayed with the red and bold font.

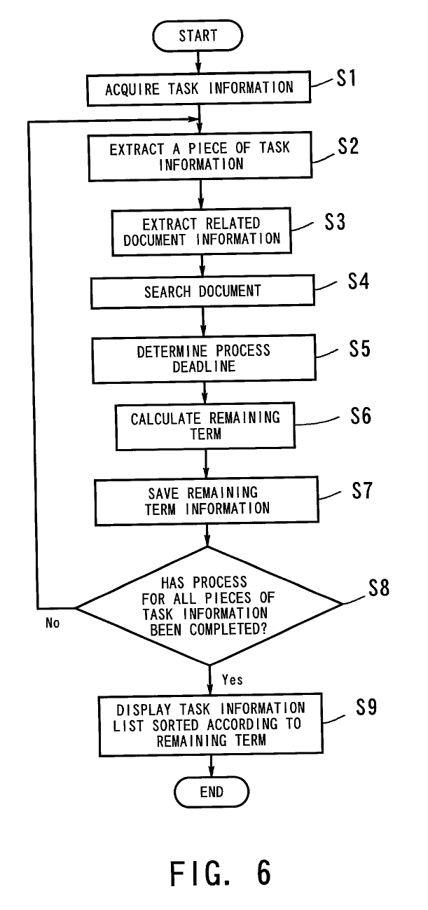

A description will be given of an operation of the task priority decision apparatus 1 in accordance with a flowchart of FIG. 6.

[S1] The task priority decision apparatus 1 receives task information transmitted through the electronic communication medium 2, and stores it in the task information storage unit 1a.

[S2] The task information extracting unit 1b extracts one of the pieces of task information from the unit 1a.

[S3] The related document information acquiring unit 1c acquires, through the electronic communication medium 2, document information linked to the task information extracted in step S2.

[S4] The process deadline determining information retrieving unit 1d searches the whole document information extracted in step S3 by referring to the keywords 10a and the plan information 20a respectively defined in the keyword condition table 10 and the plan information table 20 stored in the condition table storage unit 1f.

[S5] The process deadline determining unit 1g determines the specific process deadline for the task being processed by using the keyword condition table 10 and the plan condition table 20 with the retrieving results obtained in step S4.

[S6] The remaining term calculating unit 1h calculates the remaining term up to the deadline determined in step S5.

[S7] The remaining term storage unit 1i stores the remaining term calculated in step S6 in such a way as to be associated with the piece of task information being processed.

[S8] It is determined whether all the pieces of task information stored in the task information storage unit 1a have been subjected to the process of steps S2 through S7. If the answer of this step is YES, the process proceeds to step S9. If a piece of task information that has not yet been processed is available, the process returns to step S2.

[S9] The task information list display unit 1l sorts the pieces of task information stored in the remaining term storage unit 1i in the increasing order of the remaining term. Then, the unit 1l displays the sorted pieces of task information in accordance with the definitions of the display format master 30 and the icon master 40.

In short, the first embodiment of the present invention operates as follows. The task information extracting unit 1b extracts a piece of task information. The related document information acquiring unit 1c acquires document information associated with the extracted piece of task information. The process deadline determining information retrieving unit 1d searches the whole document information and thus extracts a keyword and plan information therefrom. The process deadline determining unit 1g determines the process deadline for a task described in the task information by using the searching results, the keyword condition table 10 and the plan condition table 20. The remaining term calculating unit 1h calculates the remaining term up to the process deadline. Thus, it is possible to automatically make a decision as to the degree of priority of each task and to make sure the priority relationship among the tasks.

The present invention is not limited to the first embodiment of the present invention. For example, a computer may implement the above-mentioned functions of processing. In this case, the functions of the task priority decision apparatus 1 are described in a program recorded on a computer-readable recording medium. Typical examples of such a recording medium are a magnetic recording apparatus and a semiconductor memory. The program may be stored in a portable recording medium such as a CD-ROM (Compact Disk Read Only Memory) or a floppy disk, which is easily available in the market. It is also possible to store the program in a storage unit of a computer connected to a network and to transfer it to another computer through the network. When the computer executes the program, it is read out from a hard disk drive or the like built in or externally connected to the computer and is loaded to the main memory.

In the first embodiment of the present invention, the document information produced by the work processing terminal 4 is stored in the document information storage unit 3, and only the task information is sent to the task priority decision apparatus 1 at the commencement of the process. Alternatively, the task information may be transmitted to the task priority decision apparatus 1 in such a manner that related document information is attached to the task information.

In the first embodiment of the present invention, the document information storage unit 3 is provided outside of the task priority decision apparatus 1. Alternatively, the document information storage unit 3 may be incorporated into the task priority decision apparatus 1.

In the first embodiment of the present invention, the task information storage unit 1a is provided within the task priority decision apparatus 1. Alternatively, the task information storage unit 1a may be provided outside of the task information decision apparatus 1.

The first embodiment of the present invention employs the document information storage unit 3 and the task information storage unit 1a that are provided separately. Alternatively, these units may be provided in an incorporated fashion.

In the first embodiment of the present invention, the priorities of tasks are determined on the basis of only the remaining terms to the respective process deadlines. Alternatively, it is possible to introduce a keyword or plan information that indicates a task having absolute priority and to preferentially handle a piece of task information having a keyword or plan information indicative of comparatively high priority irrespective of the remaining term for the involved task.

In contrast, it is possible to introduce a keyword or plan information that indicates no necessity of processing a task with priority and to process such a task with comparatively low priority irrespective of the remaining term for the involved task.

Further, in the first embodiment of the present invention, the pieces of task information are arranged from the top of the task information list in the increasing order of the remaining term. Alternatively, it is possible to arrange the pieces of task information in another order. It is also possible to display, on a page, specific task information having a remaining term shorter than a given term and to display task information other than the above on another page.

A description will now be given of a second embodiment of the present invention.

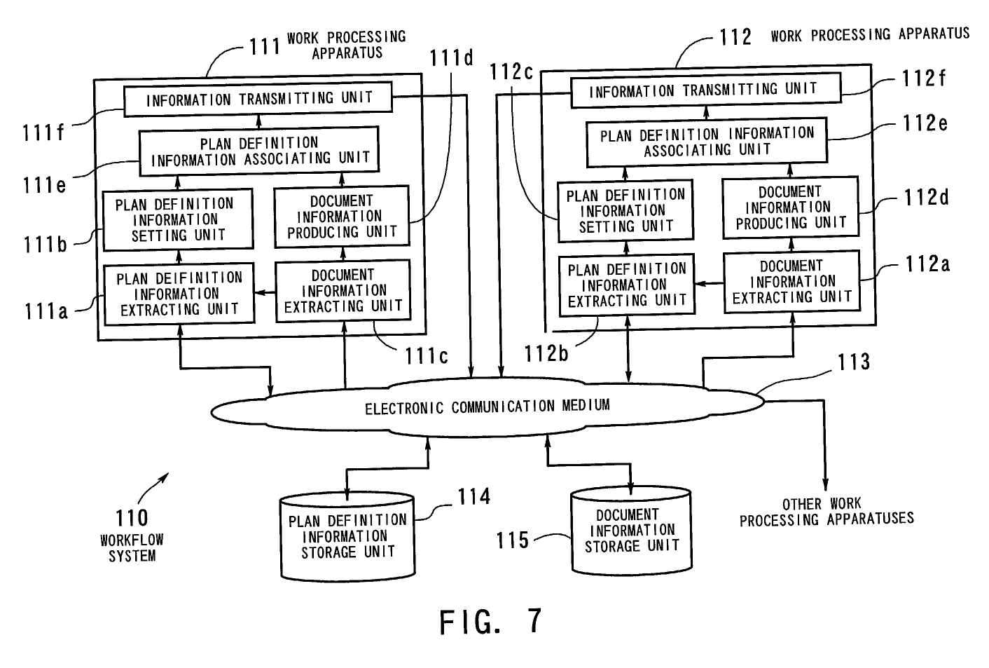

FIG. 7 is a block diagram of a workflow system 110 according to the second embodiment of the present invention.

The workflow system 110 is made up of a first work processing apparatus 111, a second work processing apparatus 112, an electronic communication medium 113, a plan definition information storage unit 114, a document information storage unit 115, and a plurality of other work processing apparatuses that are not shown for the sake of simplicity. The plan definition information storage unit 114 stores plan definition information. The document information storage unit 115 stores document information.

The work processing apparatuses 111 and 112 are computer terminals or the like allotted to individual users that use the workflow system 110. The work processing apparatuses 111 and 112 respectively include document information extracting units 111c and 112a, plan definition information extracting units 111a, 112b, plan definition information setting units 111b, 112c, document information producing units 111d, 112d, plan definition information associating units 111e, 112e, and information transmitting units 111f, 112f. Each of the document information extracting units 111c and 112a extracts a piece of document information concerning a task from the document information storage unit 115. The plan definition information extracting units 111a and 112b extract plan definition information associated with the document information extracted from the document information extracting units 111c and 112a. The plan definition information setting units 111b and 112c set plan definition information. The document information producing units 111d and 112d produce document information. The plan definition information associating units 111e and 112e associate plan definition information with document information. The information transmitting units 111f and 112f transmit document information and associated plan definition information. The document information is text information obtained by computerizing a task document such as a request form for managerial decision or a planning document. Task-originating persons produce pieces of document information concerning tasks by using the work processing apparatuses 111 and 112. The plan definition information defines a route along which the task document should be circulated or a way to circulate a delivery destination. The task-originating persons produce plan definition information using the work processing apparatuses 111 and 112. The electronic communication medium 113 is an electronic communication facility such as a LAN (Local Area Network), and electrically connects the work processing apparatuses 111 and 112, the plan definition information storage unit 114, the document information storage unit 115 and the other work processing apparatuses so that mutual communications can take place.

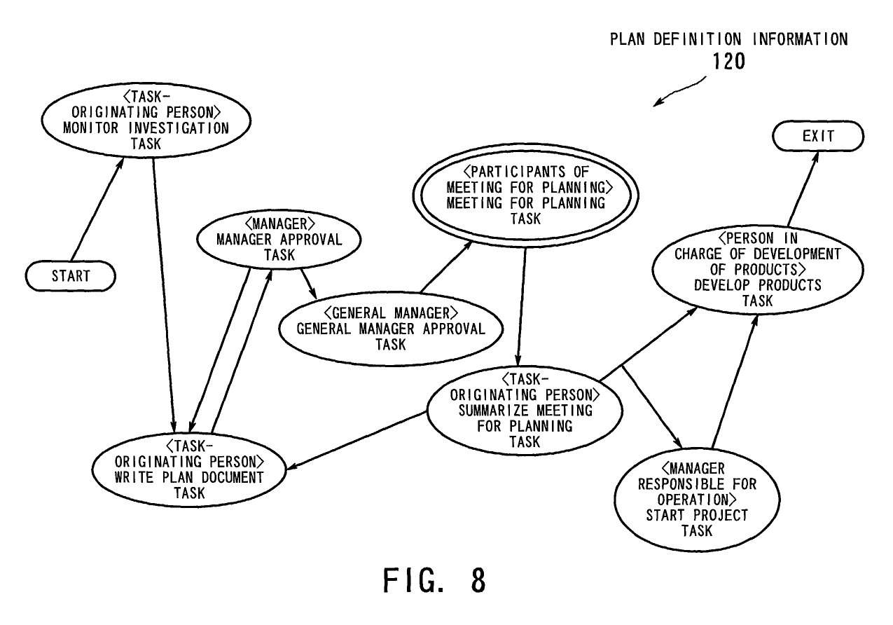

FIG. 8 illustrates an example of plan definition information 120.

Document information that describes a plan document based on a monitor investigation conducted by a task-originating person is serially sent to a manager and a general manager for their approvals. Then, the document information is further sent round to participants of a meeting for planning. The participants of the meeting conduct a meeting for the document information concerning the plan, and send document information concerning a summary of the results of the meeting to a manager who is responsible for an operation and a person in charge of development of products related to the operation.

A description will be given of an operation of the workflow system 110 with reference to FIG. 7.

The following description is directed to a case described below. A first task-originating person produces document information and associated plan definition information by the work processing apparatus 111. A second task-originating person who operates the work processing apparatus 112 produces document information and associated plan definition information by using the document information and the associated plan information produced by the first task-originating person.

The first task-originating person operates to the work processing apparatus 111 to produce document information and associated plan definition information by using the document information producing unit 111d. The first task-originating person may produce document information that is entirely new or is based on a template of document information stored in the document information storage unit 115 or document information produced in the past and stored therein. The plan definition information associated with the document information is produced using the plan definition information setting unit 111b. The plan definition information may be entirely new or based on a template of plan definition information stored in the plan definition information storage unit 114 or plan definition information produced in the past and stored therein.

Then, the plan definition information associating unit 111e associates the produced plan definition information with the produced document information. The associating process can be performed so that a custom property is set in the produced document information, and the plan definition information is set in the above custom property. The associating process will be described later with reference to a flowchart.

After the associating process, the document information and the plan definition information associated therewith are sent by the information transmitting unit 111f. The document information and the associated plan definition information are sent to and stored in the document information storage unit 115 and/or the plan definition information storage unit 114. The storage formation for the document information and the associated plan definition information depends on the method for associating the document information with the plan definition information. For example, when the plan definition information is set in the custom property set in the document information, both the document information and the plan definition information are stored in the document information storage unit 115. Another storing method that matches another associating method will be described with reference to a flowchart described later.

The document information produced by the first task-originating person and stored in the document information storage unit 115 is read by each work processing apparatus in a circulating route specified by the plan definition information, so that the involved persons can read the circulated document information.

When the second task-originating person wishes to originate another task, he or she uses the work processing apparatus 112 to extract document information to be used as it is.

As described above, the pieces of document information concerning the respective documents produced in the past are stored in the document information storage unit 115. The second task-originating person obtains a list of the pieces of document information stored in the document information storage unit 115. This is done through the electronic communication medium 113 by using the document information extracting unit 112a. The list thus obtained is displayed on an information display unit such as a CRT or liquid-crystal display unit. The second task-originating person uses the extracted document information, and produces new document information by using the document information producing unit 112d.

The plan definition information extracting unit 112b extracts the plan definition information associated with the document information extracted by the document information extracting unit 112a. The method for extracting depends on the method for associating the plan definition information with the document information by means of the aforementioned work processing apparatus 111. For instance, when the plan definition information is set in the custom property that is set in the document information, the plan definition information extracting unit 112b extracts the plan definition information set in the custom property that is set in the extracted document information. An method for extracting that matches another associating method will be described with reference to a flowchart described later.

The plan definition information extracted by the plan definition extracting unit 112b is displayed on the information display means such as a display, which is not shown for the sake of simplicity. The second task-originating person uses the displayed plan definition information and performs the setting of new plan definition information by using the plan definition information setting unit 112c. The plan definition information is associated with the newly produced document information by the plan definition information associating unit 112e. The associating process employed here has the same sequence as that of the plan definition information associating unit 111e of the work processing apparatus 111. The new document and the plan definition information associated therewith are transmitted by the information transmitting unit 112f, and are stored in the document information storage unit 115 and/or the plan definition storage unit 114 as in the case of those produced by the first task-originating person. Thereafter, the new document information is read by the other work processing apparatuses in accordance with the definition described by the associated plan definition information.

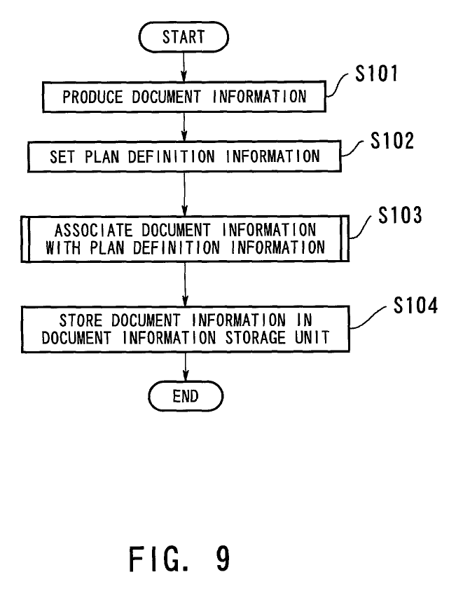

A description will be given of an operation of the workflow system 110 with reference to a flowchart of FIG. 9.

FIG. 9 is a flowchart of an operation of setting the document information and associated plan definition information performed using the work processing apparatus 111 by the first task-originating person.

[S101] The first task-originating person produces document information by using the document information producing unit 111d.

[S102] The setting of the plan definition information is performed by the plan definition information setting unit 111b.

[S103] The document information produced in step S101 is associated with the plan definition information set in step S102 by means of the plan definition information associating unit 111e.

[S104] The document information is transmitted by the information transmitting unit 111f, and is stored in the document information storage unit 115 through the electronic communication medium 113.

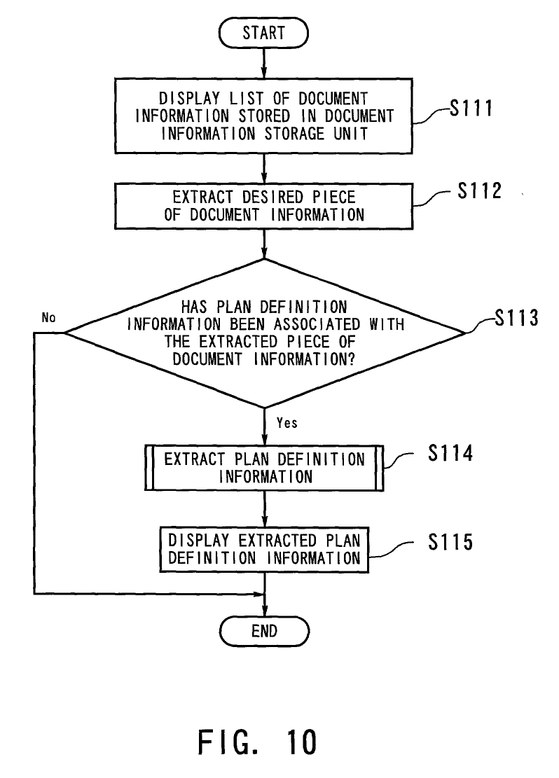

FIG. 10 is a flowchart of an example of the operation of extracting the plan definition information by the second task-originating person who uses the work processing apparatus 112.

[S111] The list of the pieces of document information is obtained from the document information storage unit 115 using the document information extracting unit 112a, and is displayed on the information display unit that is not shown for the sake of simplicity.

[S112] The second task-originating person selects a piece of document information which he or she wishes to use at it is, and the document information extracting unit 112a extracts the selected piece of document information from the document information storage unit 115.

[S113] It is determined whether the document information extracted in step S112 has been associated with the plan definition information. If associated, the process proceeds to step S114. If not, the process ends.

[S114] The plan definition information extracting unit 112b extracts the plan definition information associated with the document information extracted in step S112.

[S115] The plan definition information extracted in step S114 is displayed on the information display unit that is not shown.

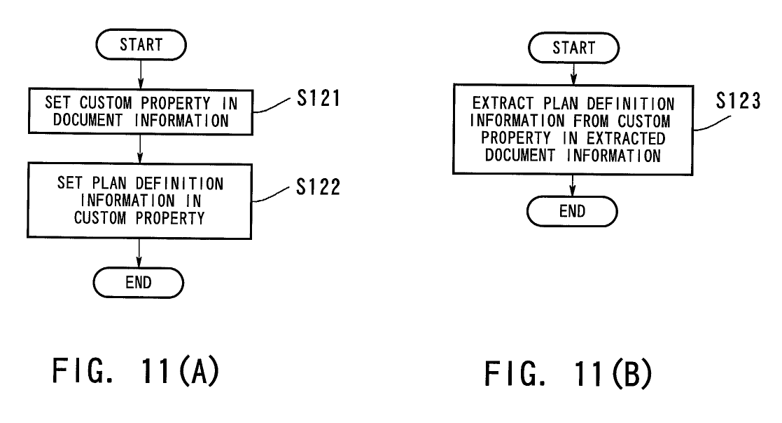

Next, a description will be given, with reference to FIGS. 11(A) and 11(B), of the method for associating the plan definition information with the document information, and a plan definition information extracting method that matches the associating method.

FIGS. 11(A) and 11(Bb) are flowcharts of a first example of the associating process. More particularly, FIG. 11(A) is a flowchart (S121, S122) that exemplifies the contents of step S103 shown in FIG. 9 in the first example of the associating process. FIG. 11(B) is a flowchart (S123) that exemplifies the contents of step S114 shown in FIG. 10 with respect to the first example of the associating process.

[S121] The custom property is set in the document information produced by the document information producing unit 111d.

[S122] The plan definition information set by the plan definition information setting unit 111b is set in the custom property set in step S121.

[S123] The plan definition information is extracted from the custom property set in the document information extracted by the document information extracting unit 112a.

In the first example of the associating process, the document information sent by the information transmitting unit 111f of the work processing apparatus 111 is stored in the document information storage unit 115. The plan definition information associated with the above document information is stored in the document information storage unit 115 as the custom property.

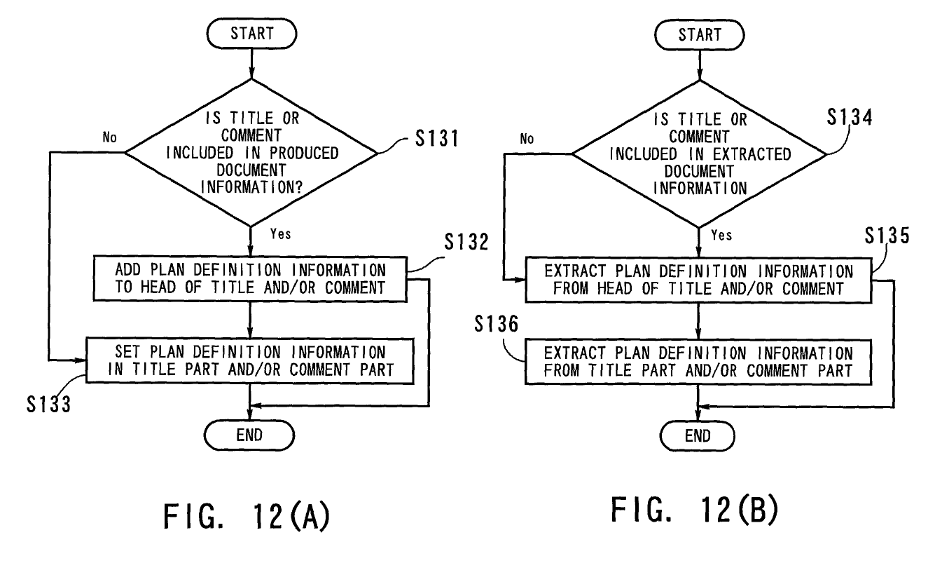

FIGS. 12(A) and 12(B) are flowcharts of a second example of the associating process. More particularly, FIG. 12(A) is a flowchart (S131-S133) that exemplifies the contents of step S103 shown in FIG. 9 in the second example of the associating process. FIG. 12(B) is a flowchart (S134-S136) that exemplifies the contents of step S114 shown in FIG. 10 with respect to the second example of the associating process.

[S131] It is determined whether or not the document information produced by the document information producing unit 111d includes any of title and comment. If the answer is affirmative, the process proceeds to step S132. If not, the process proceeds to step S133.

[S132] The plan definition information is added to the head of the body of the title or comment described in the document information.

[S133] The plan definition information is set in a title part for describing the title or a comment part for describing the comment.

[S134] It is determined whether or not any title or comment is described in the document information extracted by the document information extracting unit 112a. If the answer is YES, the process proceeds to step S135. If not, the process proceeds to step S136.

[S135] The plan definition information is extracted from the head of the body of the title or comment that is described in the document information.

[S136] The plan definition information is extracted from the title part or the comment part.

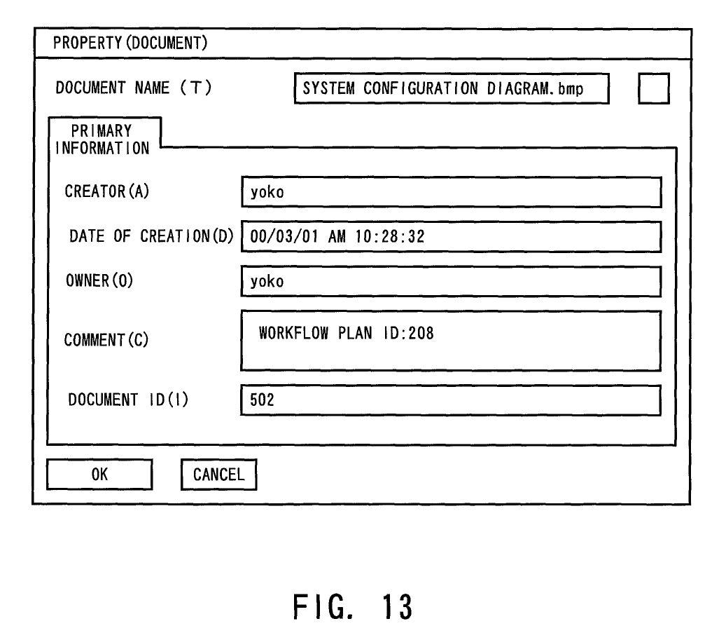

In the second example of the associating process, the document information sent by the information transmitting unit 111f of the work processing apparatus 111 is stored in the document information storage unit 115. The plan definition information associated with the above document information is stored in the document information storage unit 115 as part of the document information. FIG. 13 illustrates an example in which a plan ID for specifying a piece of plan definition information is written in a part for describing a comment on the attached document.

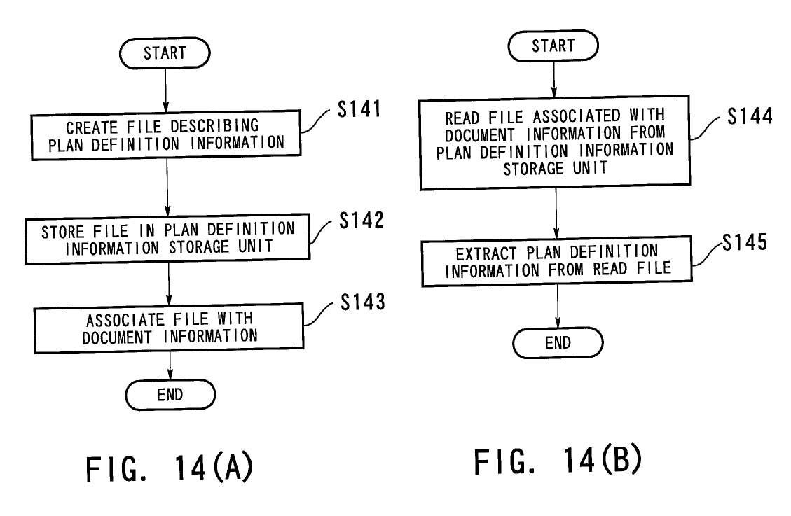

FIGS. 14(A) and 14(B) are flowcharts of a third example of the associating process. More particularly, FIG. 14(A) is a flowchart (S141-S143) that exemplifies the contents of step S103 shown in FIG. 9 in the third example of the associating process. FIG. 14(B) is a flowchart (S144-S145) that exemplifies the contents of step S114 shown in FIG. 10 with respect to the third example of the associating process.

[S141] A file is created which describes the plan definition information set by the plan definition information setting unit 111b.

[S142] The file created in step S141 is sent by the information transmitting unit 111f, and is stored in the plan definition information storage unit 114.

[S143] The file created in step S141 is associated with the document information produced by the document information producing unit 111d.

[S144] The file associated with the document information extracted by the document information extracting unit 112a, is read from the plan definition information storage unit 114.

[S145] The plan definition information is extracted from the file obtained in step S144.

In the third example of the associating process, the document information sent by the information transmitting unit 111f of the work processing apparatus 111 is stored in the document information storage unit 115.

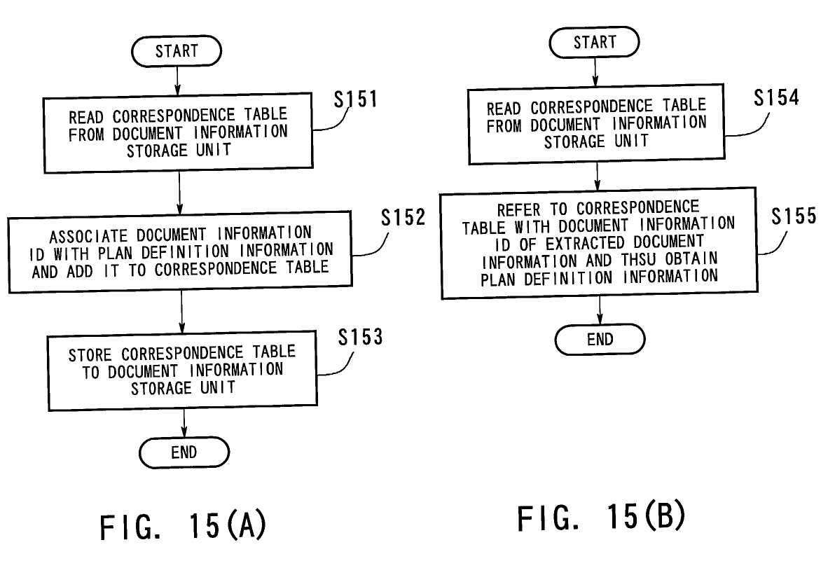

FIGS. 15(A) and 15(B) are flowcharts of a fourth example of the associating process. More particularly, FIG. 15(A) is a flowchart (S151-S153) that exemplifies the contents of step S103 shown in FIG. 9 in the fourth example of the associating process. FIG. 15(B) is a flowchart (S154-S155) that exemplifies the contents of step S114 shown in FIG. 10 with respect to the fourth example of the associating process.

In this example, a correspondence table is created and stored in the document information storage unit 115. The correspondence table includes a document information ID which corresponds to a piece of document information stored in the document information storage unit 115 one by one, and a piece of plan definition information associated with the above piece of document information.

[S151] The correspondence table is read from the document information storage unit 115 through the electronic communication medium 113.

[S152] The document information ID of the document information newly produced by the document information producing unit 111d is associated with the plan definition information newly set by the plan definition information setting unit 111b. Then, the plan definition information with the document information ID added thereto is added to the correspondence table.

[S153] The correspondence table with the new plan definition information and document information ID added thereto is transmitted by the information transmitting unit 111f, and is then stored in the document information storage unit 115.

[S154] The correspondence table is read from the document information storage unit 115 through the electronic communication medium 113.

[S155] The correspondence table is referred to with the document information ID of the extracted document information, so that the plan definition information can be obtained.

In the fourth example of the associating process, the document information sent by the information transmitting unit 111f of the work processing apparatus 111 is stored in the document information storage unit 115. The plan definition information associated with the above document information is stored in the document information storage unit 114 as part of the correspondence table.

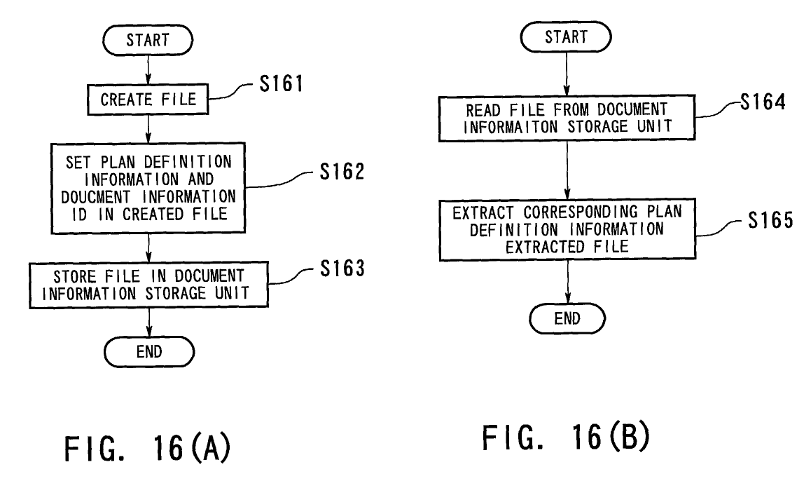

FIGS. 16(A) and 16(B) are flowcharts of a fifth example of the associating process. More particularly, FIG. 16(A) is a flowchart (S161-S163) that exemplifies the contents of step S103 shown in FIG. 9 in the fifth example of the associating process. FIG. 16(B) is a flowchart (S164-S165) that exemplifies the contents of step S114 shown in FIG. 10 with respect to the fifth example of the associating process.

[S161] A file is created.

[S162] Plan definition information newly set by the plan definition information setting unit 111b and document information ID of document information newly produced by the document information producing unit 111d are set in the file created in S161.

[S163] The file is sent by the information transmitting unit 111f, and is stored in the document information storage unit 115.

[S164] The file is read from the document information storage unit 115 through the electronic communication medium 113.

[S165] The plan definition information corresponding to the document information ID of the document information extracted by the document information extracting unit 112a is extracted from the read file.

In the fifth example of the associating process, the document information sent by the information transmitting unit 111f of the work processing apparatus 111 is stored in the document information storage unit 115. The plan definition information associated with the above document information is stored in the document information storage unit 115 as part of the created file.

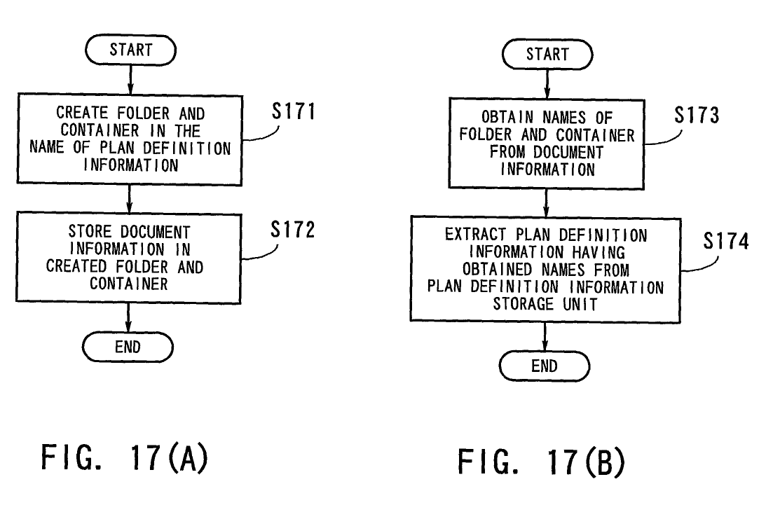

FIGS. 17(A) and 17(B) are flowcharts of a sixth example of the associating process. More particularly, FIG. 17(A) is a flowchart (S171, S172) that exemplifies the contents of step S103 shown in FIG. 9 in the sixth example of the associating process. FIG. 17(B) is a flowchart (S173, S174) that exemplifies the contents of step S114 shown in FIG. 10 with respect to the sixth example of the associating process.

[S171] A folder and a container (the parent directory of the folder) is created in the name of the plan definition table set by the plan definition information setting unit 111b.

[S172] Document information produced by the document information producing unit 111d is stored in the created folder and container.

[S173] The names of the folder and container stored in the document information produced by the document information producing unit 111d are obtained.

[S174] Plan definition information having the names of the folder and container obtained in step S173 is extracted from the plan definition information storage unit 114 through the electronic communication medium 113.

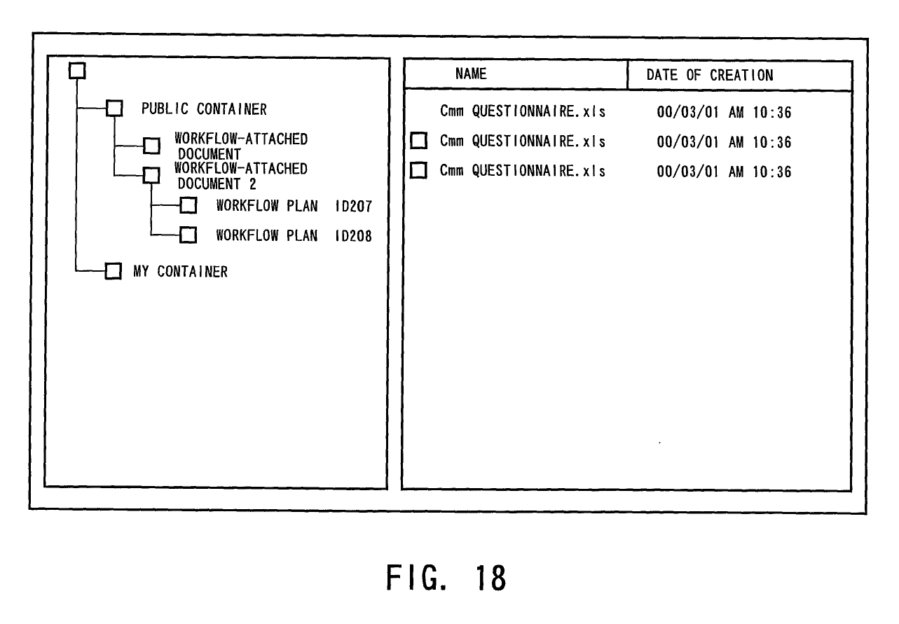

In the sixth example of the associating process, the document information, which is stored in the folder and container, is sent by the information transmitting unit 111f of the work processing apparatus 111, and is then stored in the document information storage unit 115. The plan definition information associated with the above document information is transmitted by the information transmitting unit 111f of the work processing apparatus 111, and is stored in the plan definition information storage unit 114. FIG. 18 exemplarily illustrates that a plan ID specifying a piece of plan definition information is set in a folder in which a task document to be circulated is stored.

In short, the second embodiment of the present invention operates as follows. The plan definition information associating unit 111e of the work processing apparatus 111 associates a piece of plan definition information with a piece of document information produced by the first task-originating person. The piece of document information associated with the piece of plan definition information is then stored in the document information storage unit 115. The document information extracting unit 112a of the work processing apparatus 112 extracts a piece of document information stored in the document information storage unit 115. The plan definition information extracting unit 112b extracts the piece of plan definition information associated with that of document information extracted by the document information extracting unit 112a. Thus, it is possible to obtain plan definition information related to the previously created document information stored in the document information storage unit 115. As a result, the second task-originating person can use the plan definition information thus obtained and set new plan definition information concerning new document information efficiently.

The present invention is not limited to the second embodiment of the present invention. For example, a computer may implement the above-mentioned functions of processing. In this case, the functions of the work processing apparatuses 111 and 112 are described in a program recorded on a computer-readable recording medium. Examples of such a recording medium are a magnetic recording apparatus and a semiconductor memory. The program is stored in a portable recording medium such as a CD-ROM (Compact Disk Read Only Memory) or a floppy disk, which is easily available in the market. It is also possible to store the program in a storage unit of a computer connected to a network and to transfer it to another computer. When the computer executes the program, it is read out from a hard disk drive or the like built in or externally connected to the computer and is loaded to the main memory.

Although the second embodiment of the present invention employs the plan definition information storage unit 114 and the document information storage unit 115 that are provided separately, these units may be incorporated.

In the aforementioned structure of the second embodiment of the present invention, the plan definition storage unit 114 and the document information storage unit 115 are provided outside of the work processing apparatuses 111 and 112. Alternatively, at least one of the plan definition storage unit 114 and the document information storage unit 115 may be provided within the work processing apparatuses 111 and 112.

In the foregoing, the first task-originating person uses the work processing apparatus 111, and the second task-originating person uses the work processing apparatus 112. Alternatively, the first and second task-originating persons use the second and first work processing apparatuses 112 and 111, respectively. Also, the first and second task-originating persons may use the same work processing apparatus.

In the aforementioned description, the task documents are stored in the document information storage unit 115 of the workflow system 110 for management. Alternatively, it is possible to store task documents in a document management system that is a document database separate from the workflow system 110 and to collaborate the document work system with the workflow system 110. In such collaboration, the document management system plays the role of the document information storage unit 115.

According to the present invention, task information is extracted and document information associated with the task information is acquired. The acquired document information is searched in order to extracts information used for determining a process deadline. Then, a process deadline for task information is determined on the basis of the extracted information for determining a process deadline. The remaining term available up to the process deadline is calculated. Thus, it is possible to automatically make a decision as to the degree of priority of tasks and to make sure process priority of tasks.

Also, according to the present invention, the plan definition information is associated with the document information produced by the first task-originating person who uses the plan definition information associating unit of the first work processing apparatus. The document information with which the plan definition information is associated is stored in the document information storage unit. The document information stored in the document information storage unit is extracted by the document information extracting unit of the second work processing apparatus. Then, the plan definition information associated with the extracted document information is extracted by the plan definition information extracting unit. Thus, new plan definition information related to new document information originated by the second task-originating person can be set efficiently.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A task priority decision apparatus deciding priority of pieces of task information, comprising:
task information extracting means for extracting a piece of task information;
related document information acquiring means for acquiring document information related to said piece of task information extracted by said task information extracting means;
process deadline determining information retrieving means for extracting process deadline determining information from said document information acquired by said related document information acquisition means; and
process deadline determining means for determining a process deadline for said piece of task information on the basis of the process deadline determining information extracted by said process deadline determining means.

2. The task priority decision apparatus according to claim 1, wherein:
the process deadline determining information includes a keyword;
said task priority decision apparatus further comprises condition table registering means for registering a keyword condition table having keywords and process deadlines associated with said keywords; and
said process deadline determining means determines said process deadline for said piece of task information by referring to said condition table registering means with the keyword extracted by said process deadline determining information retrieving means.

3. The task priority decision apparatus according to claim 1, wherein:
the process deadline determining information includes a piece of plan information indicating a kind of a task described by said piece of task information;
said task priority decision apparatus further comprises condition table registering means for registering a plan condition table having pieces of plan information and process deadlines associated with said pieces of plan information; and
said process deadline determining means determines said process deadline for said piece of task information by referring to said condition table storage means with said piece of plan information extracted by said process deadline determining information retrieving means.

4. The task priority decision apparatus according to claim 1, further comprising:
remaining term calculating means for calculating a remaining term up to said process deadline determined by said process deadline determining means;
task information list display means for displaying a task information list for each piece of task information; and
display format master storage unit for storing a display format master that defines a display format of the task information list in correspondence with said remaining term,
said task information list display means displaying said task information list in the display format defined in said display format master.

5. The task priority decision apparatus according to claim 4, wherein said task information list display means displays items of the task information list arranged in an increasing order of the remaining term.

6. A task priority decision method for making a decision on priorities of pieces of task information, comprising the steps of:
extracting a piece of task information;
acquiring document information related to said piece of task information extracted;
extracting process deadline determining information from said document information acquired;
determining a process deadline for said piece of task information on the basis of the process deadline determining information; and
calculating a remaining term up to said process deadline.

7. A computer-readable recording medium storing a program causing a computer to execute the steps of:
extracting a piece of task information;
acquiring document information related to said piece of task information extracted;
extracting process deadline determining information from said document information acquired;
determining a process deadline for said piece of task information on the basis of the process deadline determining information; and
calculating a remaining term up to said process deadline.

8. A workflow system for performing a given work by computerizing and circulating a task document, comprising:
a first work processing apparatus including plan definition information associating means for associating plan definition information that defines a way to circulate the task document with task information formed by computerizing the task document;
a document information storage unit storing said document information with which said plan definition information is associated; and
a second work processing apparatus including document information extracting means for extracting said document information from said document information storage unit, and plan definition information extracting means for extracting said plan definition information associated with said document information extracted by said document information extracting means.

9. The workflow system according to claim 8, wherein said first work processing apparatus is incorporated into said second work processing apparatus.

10. A workflow system performing a given work process by circulating a document stored in a document management system for managing task documents, said workflow system comprising:
plan definition information associating means for associating document information concerning the task documents with plan definition information that defines a way to circulate the task documents: and
plan definition information extracting means for extracting said plan definition information associated with the task documents stored in the document management system.

11. A work processing method for performing a given work by computerizing and circulating a task document, comprising the steps of:
associating plan definition information defining a way to circulate the task document with task information formed by computerizing the task document;
storing said document information with which said plan definition information is associated;
extracting said document information stored; and
extracting said plan definition information associated with said document information extracted.

12. A computer-readable recording medium storing a program that causes a computer to execute the steps of:
associating plan definition information defining a way to circulate the task document with task information formed by computerizing the task document;
storing said document information with which said plan definition information is associated;
extracting said document information stored; and
extracting said plan definition information associated with said document information extracted.
